(19) United States
(12) Patent Application Publication
(10) Pub. No.: US 2013/0063462 A1
(43) Pub. Date: Mar. 14, 2013

(54) TILE-BASED IMAGE PROCESSING USING MIPMAPS

(71) Applicants: JEFFREY R. BLOOMFIELD, Bothell, WA (US); MICHAEL VINCENT ONEPPO, Seattle, WA (US); STEPHEN P. PROTEAU, Bothell, WA (US); BIN CHEN, Bellevue, WA (US)

(72) Inventors: JEFFREY R. BLOOMFIELD, Bothell, WA (US); MICHAEL VINCENT ONEPPO, Seattle, WA (US); STEPHEN P. PROTEAU, Bothell, WA (US); BIN CHEN, Bellevue, WA (US)

(73) Assignee: MICROSOFT CORPORATION, REDMOND, WA (US)

(21) Appl. No.: 13/228,204

(22) Filed: Sep. 8, 2011

(51) Int. Cl. G09G 5/00

(52) U.S. Cl. 345/582

(57) ABSTRACT

Mipmaps are used to optimize image rendering by intelligently determining which generated mipmaps can be reused and then storing the reusable mipmaps in cache for quick retrieval later. A graphic transformation application (GTA) working with or executed by a graphics processing unit (GPU) identifies images to be rendered on a screen and effects to be applied such images. Transforms to carry out the effects are charged with generating mipmaps of the images, and the GTA monitors the generated mipmaps and images to be rendered to determine what mipmaps to cache for future transforms.

### BACKGROUND

To improve performance when down-scaling an image, few systems use mipmaps, and if the ones that do, at best, generate an entire mipmap pyramid complete with non-used mipmaps, which are pre-downscaled versions of an original image that can be accessed together with the original full-resolution image. Mipmaps can help optimize high-quality scaling and filtering of images by a GPU. When providing a generalized image-processing solution that utilizes the GPU to accelerate a variety of imaging operations including scaling, transformations, and per-pixel operations, effectively using mipmaps in processing a general graph of operations is difficult. Image-processing environments provide few, if any, mipmap optimizations. The environments either do not supporting mipmap use in effects graphs or simply enable transforms to internally use mipmaps for optimizations. Development of mipmap-aware transforms in the latter architecture can be costly, and in many cases the use of mipmaps is suboptimal as mipmaps may be unnecessarily generated when not needed, or, even more problematic, not generated correctly when needed.

Transforms are often applied to computer images to modify the images in a particular way. Image transformation generally includes a variety of activities such as rotating an image or providing an effect for the image, such as a blur effect. A GPU can receive an initial image specification, perform a desired transform, and then return information corresponding to a transformed image that allows the transformed image to be drawn or displayed on a display screen. An architecture where transforms must perform rendering work and optimizations internally and in isolation from one another is generally less effective and convenient than one in which a GTA consumes declarative transform data and reasons about the best rendering and caching strategy.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments described herein use mipmaps efficiently when rendering effects for computer graphics. Mipmaps are used to optimize image rendering by intelligently determining which generated mipmaps can be reused and then storing the reusable mipmaps in cache for quick retrieval later. Images and effects to be displayed are identified, as are transforms to carry out the effects. To perform the transforms, mipmaps of the images may be generated, unless the mipmaps are already saved in cache. Mipmaps that can be reused by other transforms for images of effects cached for quick later retrieval.

In another embodiment, a GTA executed by a GPU and/or processor of some sort determines what mipmaps will need to be generated for different transforms to carry out the effects. If the same mipmaps need to be generated for two different instances of an effect, the GTA generates the mipmaps once, caches the mipmaps, and then uses the cached mipmaps for the second.

### BRIEF DESCRIPTION OF THE DRAWINGS

The present invention is described in detail below with reference to the attached drawing figures, wherein:

FIG. 1 is a block diagram of a schematic for a computing device, according to one embodiment;

FIG. 1 is a block diagram of an image divided into different portions, according to one embodiment;

FIG. 2 is a diagram of mipmaps for an image, according to one embodiment;

FIG. 3 is a diagram of an image having transforms applied thereto, according to one embodiment;

FIG. 4 is a diagram of a display area on a computing device with multiple images with effects applied in different screen areas, according to one embodiment;

FIG. 5 is a diagram of pixels associated with an image on a screen having a transform applied, according to one embodiment; and

FIGS. 6-7 are diagrams of different flows for optimizing mipmap generation and usage during the performance of effects on images, according to one embodiment.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments described herein are generally directed towards using mipmaps more efficiently when performing effects in computer graphics. When given an image-processing task defined as a general graph of image processing operations, an embodiment effectively optimizes any scaling or filtering operations in the graph using mipmaps by providing an automatic service, through a GTA, for generating mipmaps as necessary from the output of a transform. The service provides multiple automatic features that minimize the amount of processing needed, such as only generating the mipmaps needed by the downstream transform, intelligently tiling the mipmap pyramid, and caching the result. As a result, scaling and filtering performance on GPUs is improved with little to no additional complexity in the image transforms used in the graph. A transform need only to request a set of mipmaps, and the mipmaps will be produced by the service.

In one embodiment, an aspect is directed to monitoring mipmaps to be generated for effects for images and caching mipmaps that will need to be used for different images. For the images to be displayed on a computing device, a GTA determines what mipmaps will need to be generated for different transforms to carry out the effects. If the same mipmaps need to be generated for two different instances of an effect, the GTA generates the mipmaps once, caches the mipmaps, and then uses the cached mipmaps for the second. Not all embodiments cache the mipmaps, however. Instead, some may store the mipmaps in another memory store, transmit the mipmaps to another computing device, or discard the mipmaps entirely.

In another embodiment, an aspect is directed to a computing device equipped with a GPU that can execute a GTA capable of optimizing effect rendering by caching reusable mipmaps. Effects needing to be performed on images for display are determined. For each effect, the GTA determines the mipmaps needed. When mipmaps are needed for two different effects, the mipmaps are cached for fast later retrieval.

Embodiments described herein may take the form of a computer-program product that includes computer-useable instructions embodied on one or more computer-readable media. Computer-readable media include both volatile and nonvolatile media as well as removable and nonremovable media. By way of example, and not limitation, computer-readable media comprise computer-storage media. Computer-storage media, or machine-readable media, include media implemented in any method or technology for storing information.

Examples of stored information include computer-useable instructions, data structures, program modules, and other data representations. Computer-storage media include, but are not limited to, random access memory (RAM), cache, read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory components can store data momentarily, temporarily, or permanently.

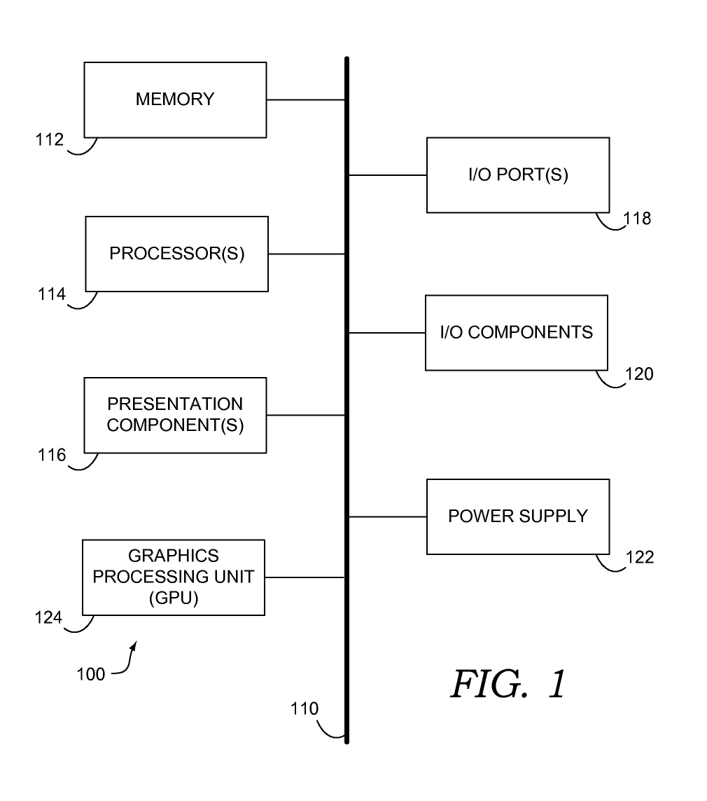

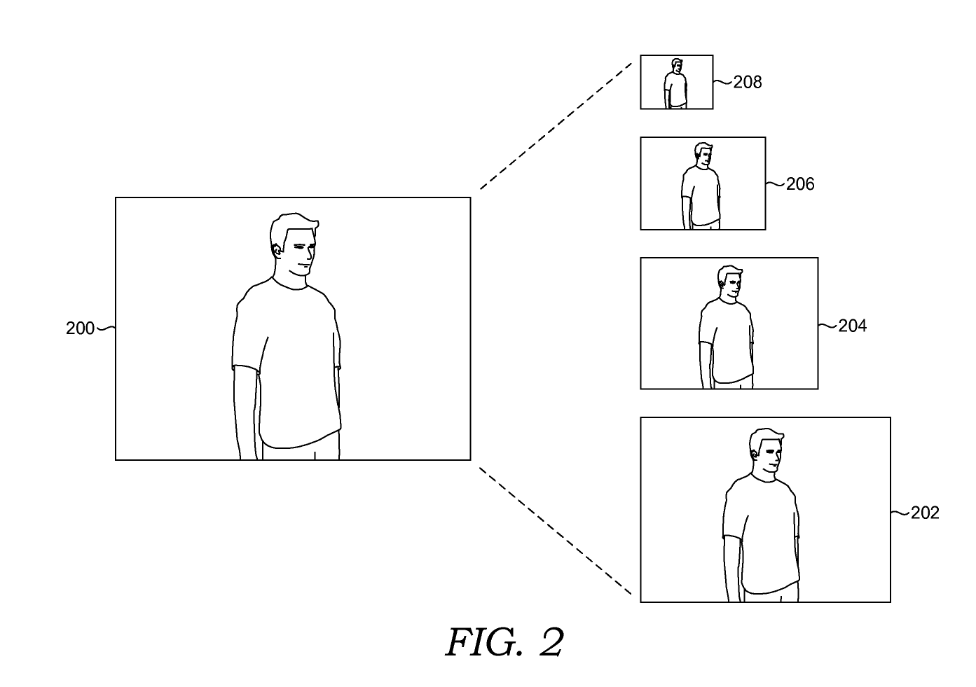

Having briefly described a general overview of the embodiments described herein, an exemplary computing device is described below. Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a conventional computer (e.g., a personal computer or laptop).

One embodiment of the invention may be described in the general context of computer code or machine-useable instructions, including computer-executable instructions such as program modules, being executed by a computer or other machine. Generally, program modules including routines, programs, objects, components, data structures, and the like refer to code that perform particular tasks or implement particular abstract data types. Embodiments described herein may be practiced in a variety of system configurations, including hand-held devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise RAM; ROM; EEPROM; flash memory or other memory technologies; CDROM, DVD or other optical or holographic media; magnetic cassettes, magnetic tape, magnetic disk storage or other magnetic storage devices, or similar tangible media that configurable to store data and/or instructions relevant to the embodiments described herein.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

Computing device 100 also includes a GPU 124 capable of simultaneously processing multiple shaders in parallel threads. GPU 124 may be equipped with various device drivers and, in actuality, comprise multiple processors. GPU 124 may be tasked with applying different transforms to images. For example, to render a Gaussian blur effect on an image, GPU 124 may scale the image, applying a horizontal blur effect, and apply a vertical blur effect, all by way of implementing different transforms. One skilled in the art will appreciate and understand that myriad transforms may be carried out by GPU 124 in order to perform different graphical effects.

A GTA typically performs image transforms using a standard application programming interface (API) with a library of image transform routines. Examples of APIs for performing image transformations include Direct2D (an API incorporated into various versions of Microsoft Windows®) and Core Image (an API developed by Apple, Inc.®). In particular, Direct2D defines transforms in a declarative manner, meaning the transform is not responsible for performing an imaging operation but is instead responsible for defining the actions necessary for performing an imaging operation. For example, if an imaging operation requires the use of a GPU pixel shader, the effect is responsible for providing the pixel shader but not for binding the pixel shader to a graphics pipeline and executing the shader on an input image. Rather, Direct2D may perform the execution. For the sake of clarity, embodiments will be discussed herein relative to Direct2D; although, one skilled in the art will understand and appreciate that other APIs may be used.

A GTA may run on processors 114 and send appropriate graphics operations to GPU 124. When image data is provided to the GTA or GPU 124 for transformation, the application or GPU 124 can receive boundaries for an image, pixel data for the image, and a format for the pixel and/or boundary data. For some transforms, this image data is sufficient for the GTA or GPU 124 to perform the transform. For example, many types of transforms represent one-to-one transforms of pixel values. In a one-to-one transform, each pixel is mapped to another pixel. In transforms not using a one-to-one correlation of pixels, a pixel for display after the transform operation may be based on pixel values from two or more pixels of the original image data. Other transforms may require one-to-many transforms that average—or otherwise scale—many pixels together to come up with pixel data for one pixel. Such an example may include applying a transform to pixels 0-127 (i.e., 128 pixels) of a mipmap of the image to determine the RGB data for one pixel. Thus, a pixel value in the transformed image can represent a weighted average of a plurality of pixel values from the image prior to transform.

Unfortunately, transformations of image data that involve blending information from multiple pixels can pose challenges at the boundary of an image. At the boundary, some pixels will have a reduced number of neighboring pixels. As a result, a transform that blends pixel values from a plurality of pixels may be undefined or poorly defined near the edge of an image based solely on the pixel values contained in the image.

When a pixel value from beyond the edge of an image is needed, GPU 124 can sample from beyond the edge of the image. The results of such sampling will often vary depending on the type of GPU. Some models of GPU 124 can sample outside an image boundary by assigning a pixel value corresponding to the closest pixel that is within the boundary. Alternatively, an image may be part of an atlas of images. An atlas of image portions allows various images in the atlas to be arranged and/or rearranged as needed. If an image is part of an atlas of images, GPU 124 may return a pixel value from an adjacent image, regardless of whether that adjacent image is related to the current transform.

Other models of GPU 124 may lack the ability to sample beyond the image boundary. As a result, performing a transform that requires pixels from beyond the edge of an image can potentially lead to inconsistent behavior across various types of processors 114. One way for overcoming inconsistencies in performing a transform is to add pixels corresponding to additional pixel value information around an image. These additional pixels are sometimes referred to as a “gutter” of pixels or pixel information around an image. The additional pixel values are added to the image for the purpose of allowing the transform to occur in a well-defined manner. This results in a new image with larger boundaries that includes the gutter information. For example, consider a transform that requires averaging of five pixel values within a given row of pixels, such as pixel values for a central pixel and two pixels on either side. For the case in which the central pixel is on the image boundary, the transform is difficult to perform because two additional pixels are needed beyond the edge of the image. To overcome this difficulty, a gutter of additional pixel values can be added as a border around the image. Because the transform potentially needs two additional pixel values, the gutter added by GPU 124 can be two pixels beyond the original image boundary. This results in a new image with two additional pixel values added beyond the edge of the original boundary in all directions.

The pixel values for these additional pixels can be selected as any convenient values for performing a transform. For example, one convenient choice can be to assign a “transparent black” value to the additional pixels. For a pixel that is specified based on three color channels and a transparency value, a transparent black pixel can have a zero value for each of the color channels, corresponding to a black color. Additionally, the transparency value can be set to zero so that the pixel is completely transparent. During a transform, when a transparent black pixel value is used in a weighted average with other pixel values, the transparent black pixel value will not introduce a color artifact into the transformation. The overall intensity of the transformed pixel value may be reduced, but the color of the transformed pixel based on the pixel values from the original image will be preserved. Another convenient choice can be to assign pixel values for the additional pixels that correspond to the pixel value of the nearest pixel that resides within the boundaries of the image.

When only a single image is being transformed, a first image created by GPU 124 will correspond to the image with the additional transparent black gutter. The second image will correspond to the transformed image that is desired as the output. In situations where multiple images that are part of a single final texture are being transformed, the number of additional images may not be exactly a factor of two or greater. It is also noted that the above addition of transparent black pixels is specific to performing a given transform. After the transform is finished, the modified image with the transparent black gutter may be held in cache, so that when another transform is performed on the same original image, the process for adding a gutter need not be repeated.

Tile rendering, or “tiling,” refers to breaking an imaging operation into smaller chunks of processing by subdividing the resultant image, processing each sub area, and composing sub regions to produce a final image. Tiling is particularly necessary when an image-processing system cannot process an entire operation at once. For example, GPU 124 may only be able to store a maximum number of pixels for a single texture, so textures with more pixels may not be completely processed. When generating mipmaps, many pixels get averaged together. Near edges, some pixels that get averaged will be transparent black, or in some cases, something else. A goal is that the amount of bleed-in from transparent black pixels into sub-mip-levels will be symmetrical between the left/right and top/bottom, meaning that the original image, in some embodiments, must be positioned in a certain way in the original texture prior to generating mipmaps. This positioning will control, for example, whether the first pixel in the third mip level will be produced by averaging source pixels zero through three, versus by averaging source pixels two through three.

In one embodiment, the same sets of pixels gets consistently averaged together while generating mipmaps on the same transform during different rendering operations. One example when multiple rendering operations occur is when a transform somewhere downstream from the mipmap is executed in tiles. If pixels zero through three get averaged while rendering some tiles of the downstream transform, but pixels two through five get averaged while rendering others, there will be visible seams in the pixel output from the downstream transform.

As a cure, an embodiment consumes mipmap info declaratively in the GTA, allowing effects to ignore these complexities. While preparing to render effects, in one embodiment, the GTA will ask effects which regions of pixels it will need to sample in order to render a particular output rectangle. The rectangle will automatically be inflated by the GTA if extra pixels are necessary to generate mipmaps. The amount of inflation will depend on the positioning of the source image within the texture, because it affects which pixels get averaged together.

A tile-based rendering GPU will render only a portion of a texture at time. The portions of textures can be provided to the tile-based rendering GPU with expanded information to avoid the need for generating a preliminary image or texture with a gutter prior to generating a transformed image or texture.

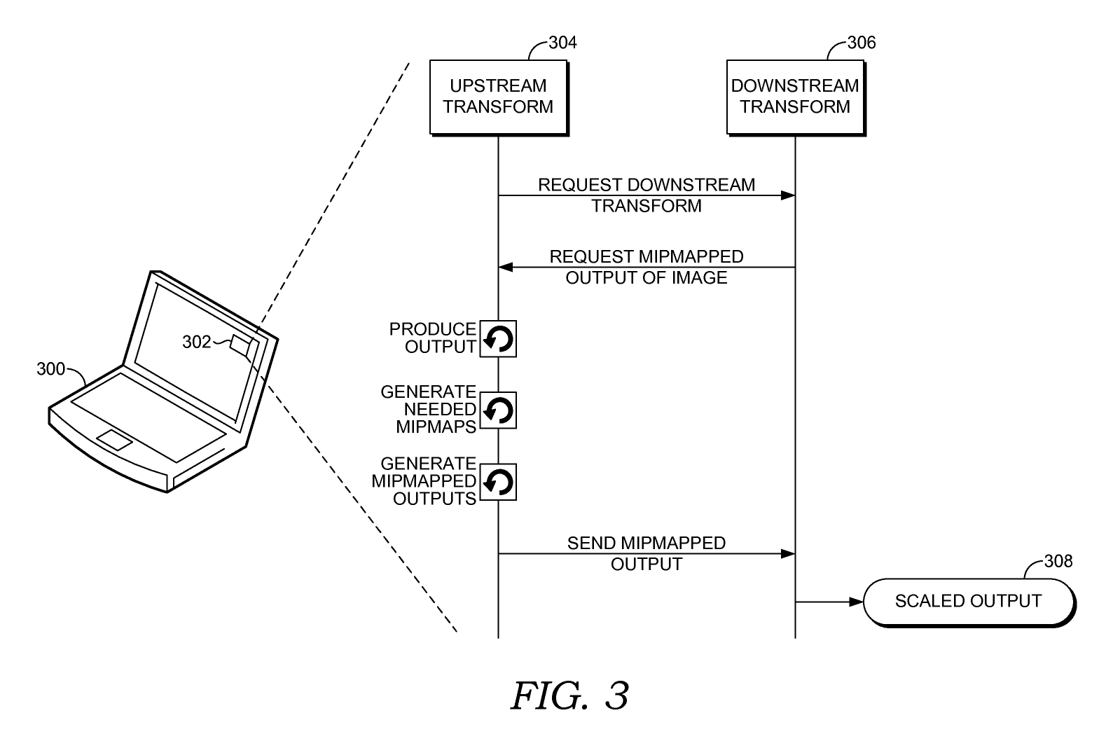

One skilled in the art will understand that mipmaps are pre-calculated, optimized versions of images usable to increase rendering speeds and reduce aliasing artifacts. FIG. 2 illustrates a diagram of different mipmaps (202, 204, 206, and 208) of image 200. Mipmaps 202-208 represent four levels of mipmaps for image 200. Mipmaps are different sized or optimized versions of an image. For example, an image with a 1680×1050 pixel resolution may have mipmaps with resolutions of 1440×900, 1280×960, 1280×720, 1024×768, and 800×600 pixels. Mipmaps are not limited to different screen resolutions, however, as mipmaps are often generated in power-of-two sizes.

Each bitmap image of a mipmap set is a version of the main texture, but at a certain reduced level of detail. While the main texture would still be used when the view is sufficient to render it in full detail, a renderer may switch to a suitable mipmap image—or perhaps interpolate between the two nearest mipmaps if something trilinear filtering is activated—when the texture is viewed from a distance or at a small size. Rendering speeds increase because the number of texture pixels (i.e., “texels”) being processed can be much lower than with the larger textures. And due to the fact that mipmaps are pre-generated anti-aliased bitmaps, artifacts are reduced in the transformed image, thus producing high quality result while saving the effort to filter an image with high quality at real time on GPU

A “mipmap pyramid” is a set of mipmaps of an image. If, for example, a texture has a basic size of 256×256 pixels, then the associated mipmap pyramid may contain a series of 8 images, each one-fourth the total area of the previous one: 128×128 pixels, 64×64, 32×32, 16×16, 8×8, 4×4, 2×2, and 1×1. Following this example a step further, if a scene is rendering this texture in a space of 40×40 pixels, then a scaled-up version of the 32×32 mipmap, a scaled-down version of the 64×64 mipmap, or interpolated version between these two mipmaps could be used as the result. One simple way to generate mipmap textures is by successive averaging; however, more sophisticated algorithms (e.g., based on signal processing or transforms) may also be used.

In one embodiment, an increase in storage space required for all the mipmaps in a mipmap pyramid is approximately a third of the original texture, due to the sum of the areas: ¼+ 1/16+ 1/64+ 1/256+ . . . 1/n converges to ⅓. For instance, for a red-blue-green (RGB) image with three channels stored in separate planes, the total mipmap can be visualized as fitting neatly into a square area twice as large as the dimensions of the original image on each side, roughly four times the original area.

In the context of mipmaps, one embodiment provides different services that both enable the execution of optimizing a graph associated with mipmaps and simplify image transforms. Using the embodiment, a developer does not need to write significant code to handle mipmaps; instead, the developer need only include a small declaration to use the mipmap optimizations described herein. All an image or texture effect needs to do is simply declare that an input needs a specific set of mipmaps or mip levels, and the GTA (in one embodiment) automatically generates a corresponding mipmap pyramid.

One embodiment coordinates the generation and caching for quick retrieval of mipmaps for all images. A GTA determines that multiple instances of an image are required by different textures, so the GTA caches mipmaps from the first instance to be used for the second. In the event, the mipmap levels differ between the instance, one embodiment caches the most complicated level. For example, if two mip levels are used in one instance of a “drop-shadow” effect and four levels are used in a second instance of the drop-shadow effect, the GTA caches the four instances.

One optimization reduces the number of mipmaps generated to only those needed at any particular time. In one embodiment, effects will tell the GTA how many mip levels the effect requires. For example, a “scale” effect will calculate the number of mip levels based on the selected scale factor. The GTA sometimes further restricts the number of mip levels that the effect may sample, for example based on the size of the source image.

Cache on computing device may already be filled with requisite mipmaps, and if so, the mipmaps can simply be retrieved. The GTA may also intelligently check effects and transforms being performed or to be performed and determines whether any required mipmaps can be used multiple times. To that end, the GTA traverses an image to determine what effects are to be performed for what images. The GTA also determines what mipmaps are necessary for each effect. Using the required effects, images, and mipmaps for each effect, the GTA optimizes performance by determining whether any required mipmaps can be used for multiple effects.

When an effect needs to sample a point at multiple levels of detail, one embodiment generates the required mipmaps for the top level and then scales the mipmap down to the appropriate rendering size. And when using tile rendering, the same sets of pixels being averaged between different mipmap levels are averaged for every tile—to prevent imprecise rendering. Additionally, some embodiments may add transparent black pixels when a desired transform or effect requires fewer pixels in an image or tile region. Such an embodiment may also coordinate the added transparent black pixels in a manner so that the bleed-in from border pixels, which are typically transparent black, is symmetrical between left/top and bottom/right edges. If the number of additional pixels is not sufficient, the GTA can create a preliminary image to accommodate requirements of a transform.

Additionally, in some embodiments the addition of the expanded information by another processor can occur in parallel with another limiting process, allowing the expanded information to be added without an apparent cost in time. For example, when an image is loaded or saved to disk, the speed of the read or write from the disk (or other longer term storage medium) to the memory used by a processor will typically be slow relative to a process operating on data that is already in memory or cache.

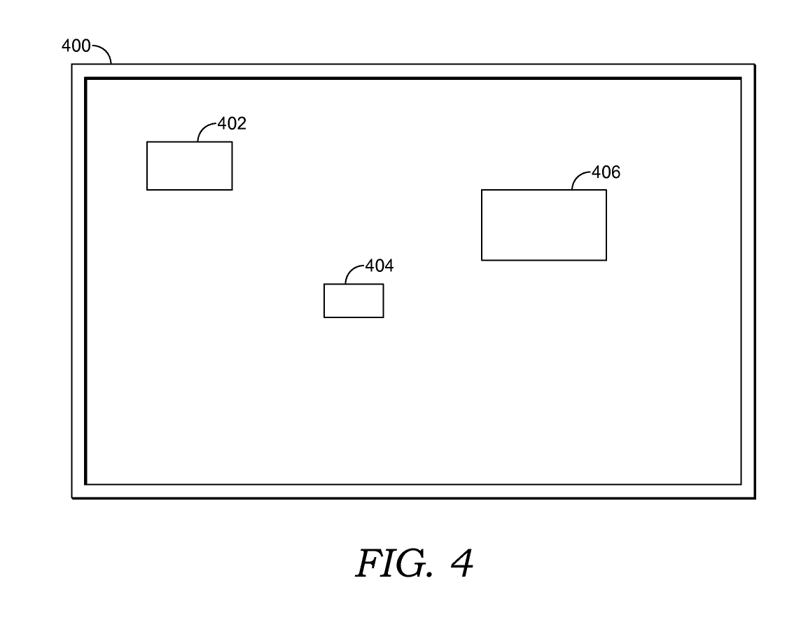

FIG. 3 is a diagram of an image 302 having transforms applied thereto, according to one embodiment. A computing device 300 is looking to render an image 302 with a particular effect. As shown in the expanded portion, two transforms are being applied to image 302 to create the: upstream transform 304 and downstream transform 306. The shown steps are performed by a GTA, GPU, and/or processor on computing device 300. The illustrated steps are provided to explain merely one embodiment, not every embodiment. Alternative embodiment may use different processing steps, or perhaps some or all of the steps shown in a different sequence or in parallel with each other.

Upstream transform 304 may be an effect (e.g., blur, shadow drop, etc.) of an image needing to be drawn on the screen. Downstream image 306 represents a scaled down version of the image capable of fitting on the screen. A request is submitted for the downstream transform 306 to applied to the image. Downstream transform 306 requests the mipmapped output of an image. To generate the mipmapped output, upstream transform 304 produces an output that includes the required pixels for the scaled version of the image. The required pixels may indicate the number of pixels, boundary of the pixels, and position of the pixels on the screen. The required mipmaps of the image are generated or retrieved. In one embodiment, a cache of computing device 300 is checked for any required mipmaps, and cached versions of the required mipmaps are used if found in the cache.

Through averaging or blending the generated mipmaps, color data for the image can be generated to fit the required pixels. For example, an image set to fit in 10×10 pixels may be averaged down from mipmaps of the image in 100×100 pixels As mentioned herein, sometimes averaging or blending mipmaps is not perfect, so some embodiments will add transparent black pixels intelligently added to mipmaps or blended versions of mipmaps to create accurate pixel data for the scaled-down version.

The resultant mipmap-blended output is the “mipmapped output,” is sent to downstream transform 306 to be rendered on the screen. From the mipmapped output, downstream transform 306 creates the appropriate scaled output 308 of the image with the effect and renders scaled output 308 on the screen.

While FIG. 3 merely shows a one-to-one transform relationship (i.e., one upstream and one downstream), one skilled in the art will appreciate and understand that some effects will require numerous transforms and/or various iterations of transforms. For example, five transforms may be applied sequentially or in parallel upstream before downstream transform 306. In one embodiment, a cache is checked for mipmaps needed by the transforms, and if found, the required mipmaps are pulled from the cache. The cache include mipmaps generated for different upstream transforms or may include mipmaps for other images—or instances of an image—being or already rendered on the screen.

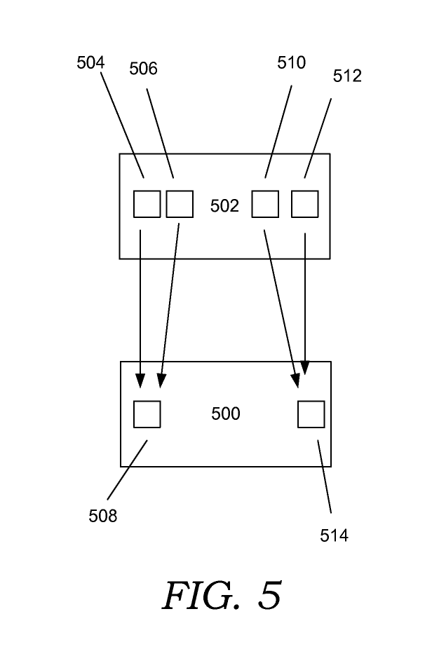

FIG. 4 is a diagram of a display area 400 on a computing device with multiple images with effects applied in different screen areas, according to one embodiment. Display area 400 needs to render images 402, 404, and 406 in the different screen areas. Effects for each image may require a transform for generating an image or effect graph. To perform the transform, mipmaps of images 402, 404, and 406 may be generated or pulled from cache. The mipmaps may then be used to generate versions of images 402, 404, and 406 that can fit within the different screen areas.

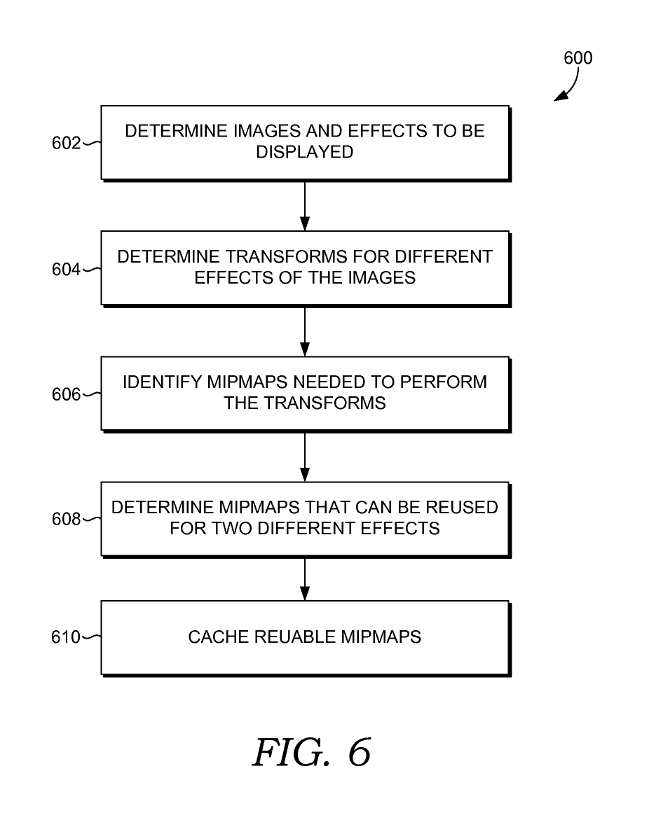

FIG. 5 is a diagram of pixels associated with an image on a screen having a transform applied, according to one embodiment. The transform blends data for mipmap 502 to generate image 500. The transform averages the pixel values within a row for two nearby pixels in mipmap 502 to produce one pixel in image 500. Other transforms can blend pixel values from pixels in the same column, or the pixels from blending can include pixels from multiple rows and/or columns. In FIG. 5, an example of performing the transform is shown for pixels on the left edge and right edge of image portion 502. The transform blends pixels 504 and 506 to generate 508. Similarly, pixels 510 and 512 are blended to generate 514. Once all pixels are blended, image 500 is ready for rendering or to be passed to another downstream transform for further processing.

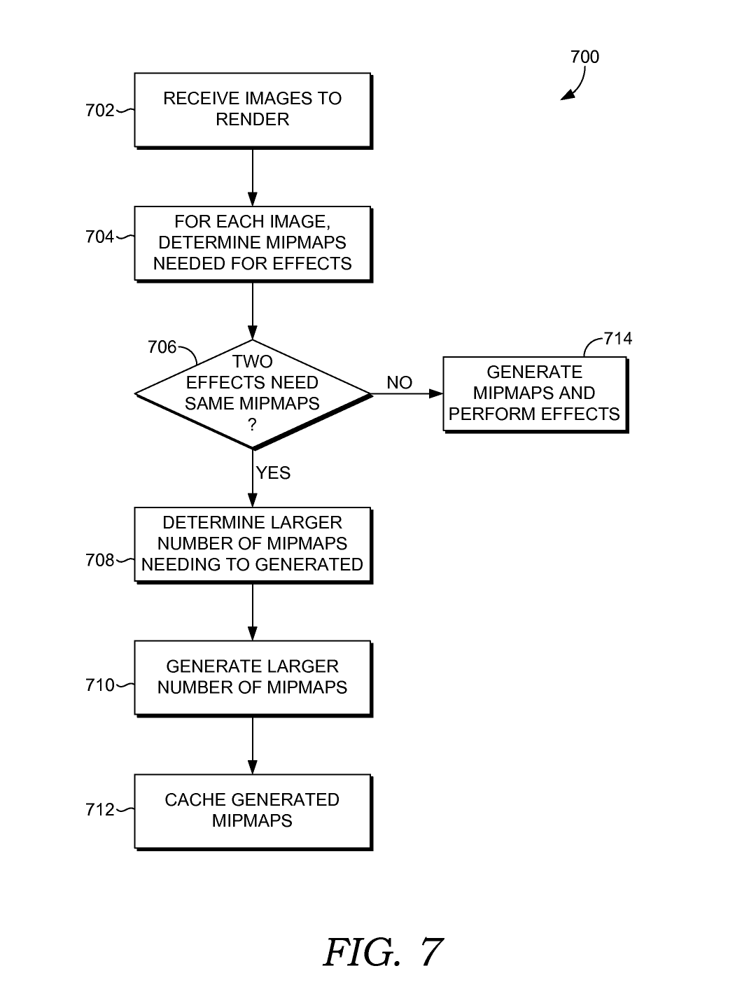

FIGS. 6-7 are diagrams of different flows for optimizing mipmap generation and usage during the performance of effects on images, according to one embodiment. Looking initially at FIG. 6, flow 600 begins when an embodiment determines what images and effects on the images to be render, as shown at 602. Transforms necessary to perform effects or render the images with the effect in a display area are determined, as shown at 604. Required mipmaps of the image are identified for the transform, as shown at 606, and any required mipmaps that can be reused for another effect or transform to be performed are identified, as shown at 608. The reusable mipmaps are saved in cache for quick retrieval later.

Turning to FIG. 7, flow 700 begin when an embodiment receives an indication of images needing to be rendered on a computing device, as shown at 702. Mipmaps required to carry out transforms or effects of each image are then determined, as shown at 704. If two effects or transforms require the same mipmaps, as shown at 706, the largest number of mipmaps being generated will be determined, as shown at 708. For instance, if transform A needs ten mipmaps of an image and transform B needs only five mipmaps, the quantity ten is noted as the largest number of mipmaps needing to be generated. The mipmaps for the larger quantity—in the above example, ten—are then generated and cached, as shown at 710 and 712, respectively. So, following the above example, ten mipmaps of the image would be generated. On the other hand, if no mipmaps can be reused between transforms or effects, all required mipmaps are generated and used to perform the desired effects, as shown at 714.

As can be understood, embodiments of the present invention provide action-based deeplinks for search results. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method of monitoring in a graphics processing unit (GPU) mipmaps associated with one or more effects for one or more images and storing a group of the mipmaps, the method comprising:
determining a plurality of images to be displayed on a computing device, the plurality of images comprising a first image and a second image;
for the first image, generating mipmaps to be used by a downstream transform; and
determining a transform for the second image uses at least one of the mipmaps.

2. The method of claim 1, further comprising:
retrieving the at least one of the mipmaps from cache;
using the at least one of the mipmaps to in execution of the transform.

3. The method of claim 1, wherein the downstream transform, when executed, maps the first image to pixels on a display of the computing device.

4. The method of claim 1, further comprising using a graphics processing unit (GPU) to execute the downstream transform and the transform.

5. The method of claim 1, caching the at least one of the mipmaps.

6. The method of claim 5, wherein each of the tiles include one or more areas where color data for pixels are determined by adding transparent black pixels.

7. The method of claim 1, wherein the transparent black pixels are added in such a manner that border pixels bleed-in symmetrically on each side of the tiles.

8. The method of claim 1, wherein the transform for the second image is an upstream transform for a second downstream transform for a third image.

9. The method of claim 8, further comprising:
determining a mipmap generated for either the first image or the second is required by the second downstream transform;
caching the mipmap; and
retrieving the mipmap from cache in execution of the second downstream transform.

10. One or more computer storage media having computer-executable instructions embodied thereon, that when executed by a processor, store one or more mipmaps associated with one or more images in a cache memory, the method comprising:
receiving images to render on a screen of a computing device;
determining effects associated with the images;
for each effect, determining a quantity of mipmaps needed to perform the effect;
determining that at least one mipmap is required for two effects; and
because the at least one mipmap is required for the two effects, storing the at least one mipmap in the cache store.

11. The media of claim 10, wherein at least of the effects requires a transform to be performed.

12. The media of claim 10, further comprising using a graphics transformation application (GTA) to perform the step of determining that at least one mipmap is required for two effects.

13. The media of claim 11, further comprising using a declarative statement to invoke the GTA.

14. The method of claim 10, further comprising creating an intermediate bitmap using the at least one mipmap.

15. The media of claim 14, further comprising:
determining that pixels in a region of the intermediate bitmap cannot be perfectly populated;
adding transparent black pixels in a manner such that border pixels bleed-in symmetrically on each side; and
ensuring that the same sets of pixels are consistently averaged together over different operations or tiles.

16. The media of claim 10, further comprising expanding an area needed to process one of the two effects in order to process a downstream transform to ensure enough pixels are available for the at least one mipmap.

17. An image-processing system, comprising:
a graphics processing unit (GPU) executing instructions stored on in memory for a graphics transformation application, wherein the graphics transformation application:
determines a mipmap needs to be generated for two separate effects,
generates the mipmap for use in a first effect of the two separate effects,
stores the mipmap in cache, and
retrieves the mipmap from the cache to perform a second effect of the two separate effects.

18. The image-processing system of claim 17, wherein the GPU that renders images on a screen in tiles.

19. The image-processing system of claim 17, wherein the second effect of the two separate effects uses two or more transforms.

20. The image-processing system of claim 17, wherein the GTA further:
determines that the first effect requires a first mipmap pyramid;
determines that the second effect requires a second mipmap pyramid; and
generates one of the first or second mipmap pyramids with the greatest number of mipmap levels.
